(19) United States
(12) Patent Application Publication
(10) Pub. No.: US 2003/0225874 A1
(43) Pub. Date: Dec. 4, 2003

(54) Managing the sending of acknowledgments

(75) Inventors: Robert S. Blackmore, Poughkeepsie, NY (US); Amy X. Chen, Poughkeepsie, NY (US); Rama K. Govindaraju, Hopewell Junction, NY (US); Chulho Kim, Poughkeepsie, NY (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY (US)

(21) Appl. No.: 10/159,163

(22) Filed: May 30, 2002

(51) Int. Cl. G06F 15/173

(52) U.S. Cl. 709/223

(57) ABSTRACT

The sending of acknowledgments is managed. An acknowledgment is delayed by a receiver until a threshold number of packets is received by the receiver or another condition is satisfied, unless a further condition arises that provokes the sending of the acknowledgment prematurely. This allows delaying techniques to be used in situations in which such techniques are typically not tolerated.

### TECHNICAL FIELD

This invention relates, in general, to message processing, and in particular, to managing the sending of packet acknowledgments from receivers of the packets to senders of the packets.

### BACKGROUND OF THE INVENTION

Message communication is a critical component of many computing environments. In one example, a packet, which includes a message or part of a message, is sent from a sender of the environment to a receiver of the environment via a communications protocol over a network. It is important for the sender to know that the packet has been received by the receiver, in order to ensure reliable communications. Thus, the receiver sends an acknowledgment to the sender indicating receipt of the packet.

Although reliable communications is important, it is also important to reduce the latency that occurs during message communication. Thus, techniques have been devised in order to improve latency, and therefore, performance. One such technique includes thresholding, in which a receiver acknowledges the receipt of a packet after a certain threshold of packets has been received from a particular sender. When the threshold is reached, a message is sent from the receiver to the sender acknowledging the packets that have been received since the last acknowledgment.

In some communications protocols, other types of acknowledgments are also sent. For example, in one-sided communications protocols, a completion acknowledgment is also sent indicating completion of a message. This acknowledgment is sent on each message completion, since the delaying of such an acknowledgment could have detrimental consequences, such as causing deadlocks or unnecessary delays at the sender. The sending of completion acknowledgments on each completion, however, significantly causes extra control traffic. In fact, the ratio of control packets to data packets is very high, especially for short messages. Thus, performance is degraded and latency is increased.

Based on the foregoing, a further need exists for a capability that improves latency during message communication. As one example, a need exists for a capability that manages the sending of acknowledgments, in order to improve latency.

### SUMMARY OF THE INVENTION

The shortcomings of the prior art are overcome and additional advantages are provided through the provision of a method of managing the sending of packet acknowledgments. The method includes, for instance, initially delaying sending at least one acknowledgment associated with one or more packets, until a first condition is satisfied; detecting a second condition provoking the sending of the at least one acknowledgment, prior to satisfying the first condition; and sending at least one acknowledgment, in response to the detecting.

In a further aspect of the present invention, a method of managing the sending of packet acknowledgments is provided. The method includes, for instance, determining that a delayed acknowledgment associated with one or more packets is to be prematurely sent; and sending the delayed acknowledgment, in response to the determining.

System and computer program products corresponding to the above-summarized methods are also described and claimed herein.

Various features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a computing environment incorporating and using one or more aspects of the present invention;

FIG. 2 depicts one example of a task sending a message to another task, which is waiting for the message;

FIG. 3 depicts one embodiment of a technique for delaying acknowledgments, used in accordance with an aspect of the present invention;

FIG. 4 depicts one embodiment of various LAPI calls issued by Task 0, including a Fence call that prohibits any other calls from being processed until the previous communications calls are complete;

FIG. 5 depicts one embodiment of the logic associated with managing the sending of acknowledgments from one or more receivers to a sender, in accordance with an aspect of the present invention;

FIG. 6 pictorially illustrates various steps of FIG. 5, in accordance with an aspect of the present invention; and

FIG. 7 pictorially illustrates a race condition in which a message arrives after the chaser message of FIGS. 5 and 6, in accordance with an aspect of the present invention.

### BEST MODE FOR CARRYING OUT THE INVENTION

In accordance with an aspect of the present invention, a capability is provided for managing the sending of packet acknowledgments from one or more receivers of the packets to one or more senders of the packets. The acknowledgments being managed in the examples herein are acknowledgments indicating completion of messages; however, other types of acknowledgments, such as receipt acknowledgments, can be similarly managed. In one example, the management includes forwarding an acknowledgment for one or more packets, when it is determined that the sender of the one or more packets is particularly waiting for the acknowledgment, even if the forwarding is earlier than anticipated.

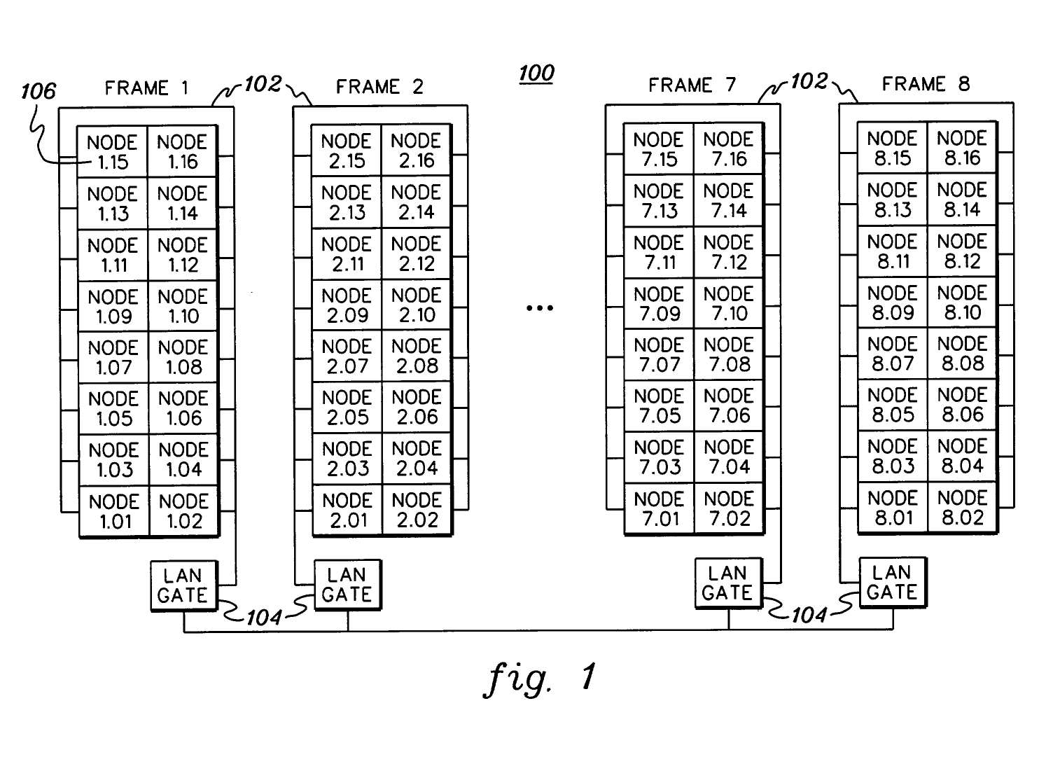

One embodiment of a computing environment incorporating and using aspects of the present invention is depicted in FIG. 1. As one example, the computing environment is a distributed computing environment 100 including, for instance, a plurality of frames 102 coupled to one another via a plurality of LAN gates 104. Frames 102 and LAN gates 104 are described in detail below.

As one example, distributed computing environment 100 includes eight frames, each of which includes a plurality of processing nodes 106. In one instance, each frame includes 16 processing nodes (a.k.a., processors), and each processing node is, for instance, a RISC/6000 computer running AIX, a UNIX-based operating system. Each processing node within a frame is coupled to the other processing nodes of the frame via, for example, at least one internal LAN connection (e.g., an Ethernet; a SP Switch offered by International Business Machines Corporation, Armonk, N.Y.; and/or other connections). Additionally, each frame is coupled to the other frames via LAN gates 104.

As examples, each LAN gate 104 includes either a RISC/6000 computer, any computer network connection to the LAN or a network router. However, these are only examples. It will be apparent to those skilled in the relevant art that there are other types of LAN gates and that other mechanisms can also be used to couple the frames to one another.

In one embodiment, entities within the computing environment (such as, operating system instances, applications, etc.) communicate with one another via a communications protocol. The communications protocol is considered herein as a component of an entity, and can be included within the entity itself or in, for instance, library code referenced by the entity. One example of such a communications protocol is the Low-Level Application Programming Interface (LAPI), offered by International Business Machines Corporation, Armonk, N.Y.

LAPI is a one-sided communications protocol, in which there is no pairing of send and receive messages. LAPI is described in detail in, for instance: U.S. Pat. No. 6,070,189 entitled “Signaling Communication Events In A Computer Network”, by Bender et al., issued May 30, 2000; U.S. Pat. No. 6,038,604 entitled “Method And Apparatus For Efficient Communications Using Active Messages”, by Bender et al., issued Mar. 14, 2000; U.S. patent application entitled “Mechanisms For Efficient Message Passing With Copy Avoidance In A Distributed System Using Advanced Network Devices”, by Blackmore et al., Ser. No. 09/619,051, filed Jul. 18, 2000; and U.S. patent application entitled “Efficient Protocol For Retransmit Logic In Reliable Zero Copy Message Transport”, by Blackmore et al., Ser. No. 09/619,054, filed Jul. 18, 2000, each of which is hereby incorporated herein by reference in its entirety.

A communications protocol is used to send messages from senders to receivers over network transports, which may be unreliable. In order to enforce the reliability of sending messages over an unreliable network transport, the communications protocol on the receive side performs certain actions. For example, the communications protocol on the receive side sends an acknowledgment for each packet (e.g., an entire message or a portion of a message) received. This allows the sending side to advance its flow control window upon receipt of the acknowledgment. If an acknowledgment is not received in a certain interval of time, the sending side assumes that the packet was lost and retransmits the packet. Typically, the receiving side waits to receive a certain (e.g., threshold) number of packets from a sender before sending a single acknowledgment message for the previous packets received, since the last acknowledgment was sent.

For certain transport protocols, such as one-sided message transport protocols (e.g., LAPI), an acknowledgment is also sent when a message completes at the target irrespective of the threshold. This is because the sending side may be waiting for the completion notification in order to continue processing. Thus, with certain functions, such as a LAPI_Put function or a LAPI_Amsend function (each of which is described in the above-referenced U.S. Pat. Nos. 6,038,604 and 6,070,189), a completion acknowledgment is not delayed (e.g., for thresholding), but is sent upon completion of the message. This is described in further detail below with reference to a LAPI_Put function.

A LAPI_Put function is used to put data into a target address on a target processor, and in one example, has the following syntax:

LAPI_Put(hndl, tgt, len, tgt_addr, org_addr, tgt_cntr, org_cntr, cmpl_cntr),

where hndl specifies a particular LAPI context; tgt indicates the target task number (i.e., target of the LAPI_Put function); len specifies the number of bytes to be transferred; tgt_addr indicates the address on the target process where data is to be copied; org_addr specifies an address on the origin process from where data is to be copied; tgt_cntr specifies the address of a target counter, which is incremented after data has arrived at the target; org_cntr specifies the address of an origin counter, which is incremented after data is copied out of the origin address; and cmpl_cntr specifies the address of a completion counter that is the reflection of the target counter at the origin. This counter is incremented at the origin after the target counter is incremented. The above parameters are only examples; additional and/or different parameters may also be specified.

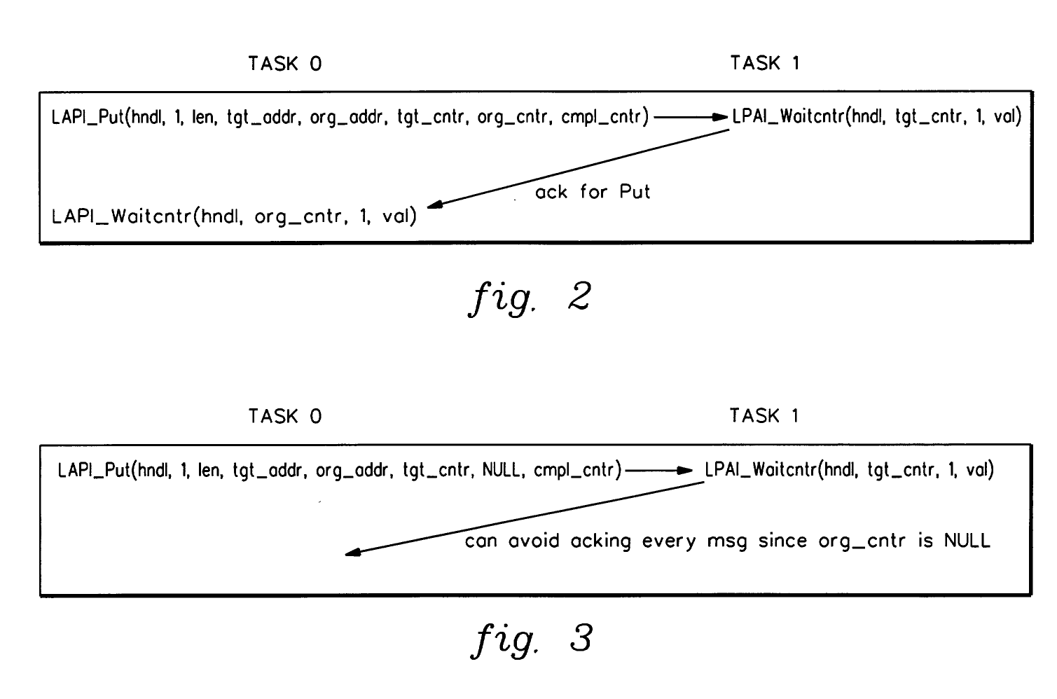

In one example, the LAPI_Put call is issued by Task 0 to Task 1 (see FIG. 2). Task 1 is waiting for the message to arrive, and thus, issues a LAPI_Waitcntr call. Task 1 polls on the target counter (tgt_cntr) specified by Task 0, as part of its LAPI_Put operation. Similarly, Task 0 is waiting on the origin side for the completion of the operation by waiting on the origin counter (org_cntr). Thus, it also issues a LAPI_Waitcntr call. Typically, the origin counter is guarding access to the origin buffer (org_addr). The user is allowed to access/modify the contents of the origin buffer only after the origin counter has been incremented by the LAPI communications library, which is part of the application's address space. In order to avoid making a copy of the origin buffer, the LAPI library forces an acknowledgment to be internally sent back by the LAPI library. Upon receipt of the acknowledgment from Task 1, Task 0 advances its flow control window and updates the origin counter notifying Task 1 that the origin buffer can now be reused by the application. In such a scenario, any delays (e.g., for thresholding) by Task 1 in returning the acknowledgment to Task 0 delays the duration for which Task 0 cannot reuse the origin buffer. Since the origin is essentially waiting for an acknowledgment (via the origin counter proxy), the target side does not take advantage of coalescing a plurality of acknowledgments into a single message and then sending the single message.

Thus, in the above scenario, an acknowledgment is sent on every message completion, in order to avoid delays. This, however, causes extra control traffic especially for short messages. In particular, for applications where a task is issuing a lot of short Put or Amsend calls, the number of control messages is high, thereby impacting the performance of the short messages in the overall application runtime. For example, an application making 100 short one-sided Put calls, results in 100 acknowledgments being sent by the receiver to the sender. Therefore, the ratio of control packets to data packets is very high (1:1). However, the impact of not sending an acknowledgment when a message completes may be even more detrimental. For instance, it may cause the application to wait a long time or even cause a deadlock situation, as described below.

Assume thresholding is to be employed, which is indicated, in one example, by the user encoding a null value in the origin counter of the Put function (see FIG. 3). Then, when the target receives the Put function with the null origin counter, the target does not force an acknowledgment immediately after message completion. Instead, the target waits for the threshold number of packets to be received from the sender, since the last acknowledgment.

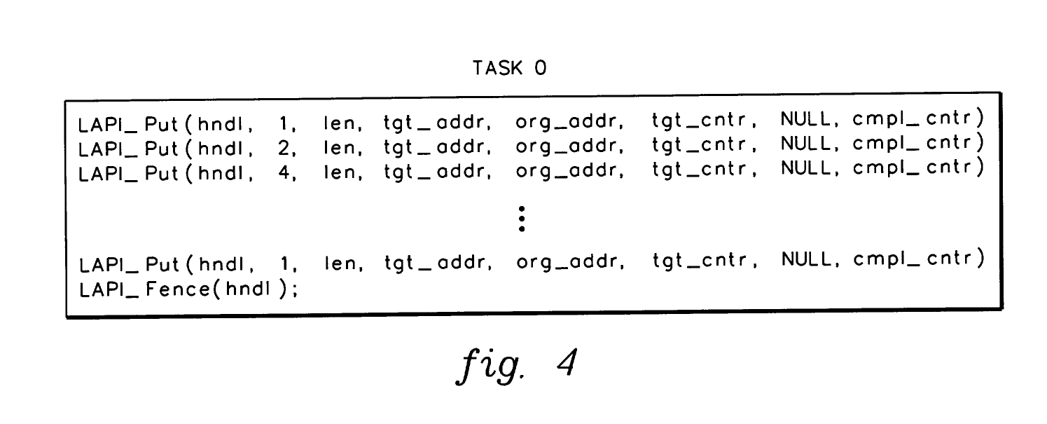

However, in some protocols, there are certain calls that when issued do not allow any other communications calls to be processed until all prior calls have completed. For instance, in LAPI, when a LAPI_Fence is executed on a task (see FIG. 4), no other LAPI communications calls made from that task after the LAPI_Fence call are allowed to start, until all LAPI calls made before the LAPI_Fence call have completed at the target and the origin. Thus, in FIG. 4, no other Put calls, as one example, can be started after the Fence call, until the previous Puts have been completed. However, if the acknowledgments for the Put messages (1 through K), where K is less than the threshold, are not sent by Task 1 until the threshold is reached, a deadlock or unnecessary delay has occurred. This is because the Fence on Task 0 cannot complete until the previous Put messages are acknowledged by Task 1. Task 1 does not send the acknowledgments back because it is waiting for the threshold number of packets from Task 0 to be reached. This cannot happen, however, because Task 1 is stalled on the Fence call. Thus, a deadlock situation or an unnecessary delay has arisen.

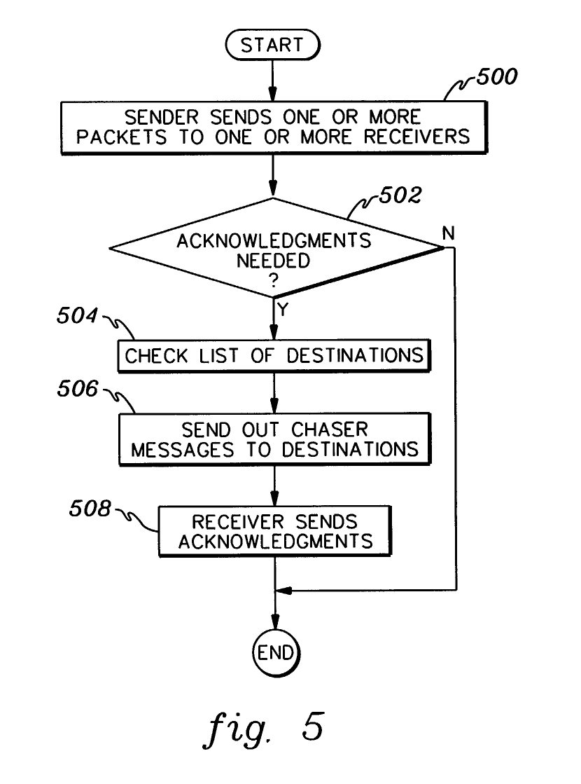

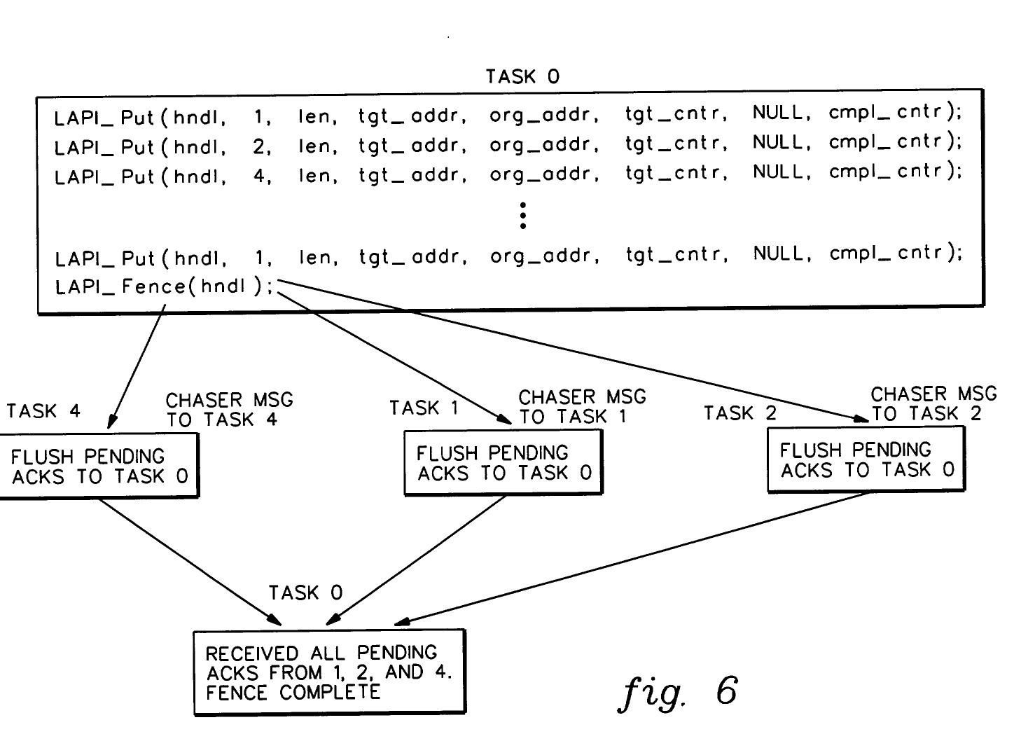

In accordance with an aspect of the present invention, a technique is provided to prevent such deadlocks, while allowing the thresholding mechanism to co-exist, and also while minimizing control messages. The technique includes, for instance, delaying the acknowledgments until the threshold is met, unless it is detected that the sender is in need of the acknowledgments (e.g., to avoid a deadlock). If such a detection is made, then the acknowledgments are prematurely sent (i.e., before the threshold). In one example, a message is sent to each receiver holding a needed acknowledgment indicating that the receiver is to flush the acknowledgment back to the sender. This is further described with reference to FIGS. 5-6.

Referring to FIG. 5, initially a sender sends one or more packets to one or more receivers, STEP 500. For example, Task 0 (FIG. 6) issues a LAPI_Put call to Tasks 1, 2 and 4. Since, in this example, a thresholding technique is being used, the receiving tasks delay sending acknowledgments, including acknowledgments indicating completion of the LAPI_Put function.

During processing, however, Task 0 issues a LAPI_Fence call. The LAPI communications library determines, based on the LAPI_Fence call in this example, that the acknowledgments are prematurely needed in order for processing to continue, INQUIRY 502 (FIG. 5). Thus, a list of destinations that received the packets is checked, STEP 504. For example, each task keeps a list of destinations from whom acknowledgments are pending. When it is determined that the acknowledgments are needed, the communications library checks the appropriate list of destinations (e.g., the list of Task 0, in this example), and sends out a chaser message to those destinations, STEP 506 (see also FIG. 6). In one example, the chaser message is a LAPI Amsend function with a special header that also encodes a sequence number, as described below. The goal of the chaser message is to signal to the target that it should flush back to the sender pending acknowledgments. Thus, each receiver receiving the chaser message sends back to the sender any pending acknowledgments, since the last acknowledgment, STEP 508. This is illustrated in FIG. 6, in which Task 0 sends chaser messages to Tasks 1, 2 and 4, and Tasks 1, 2 and 4 respond by flushing their acknowledgments back to Task 0.

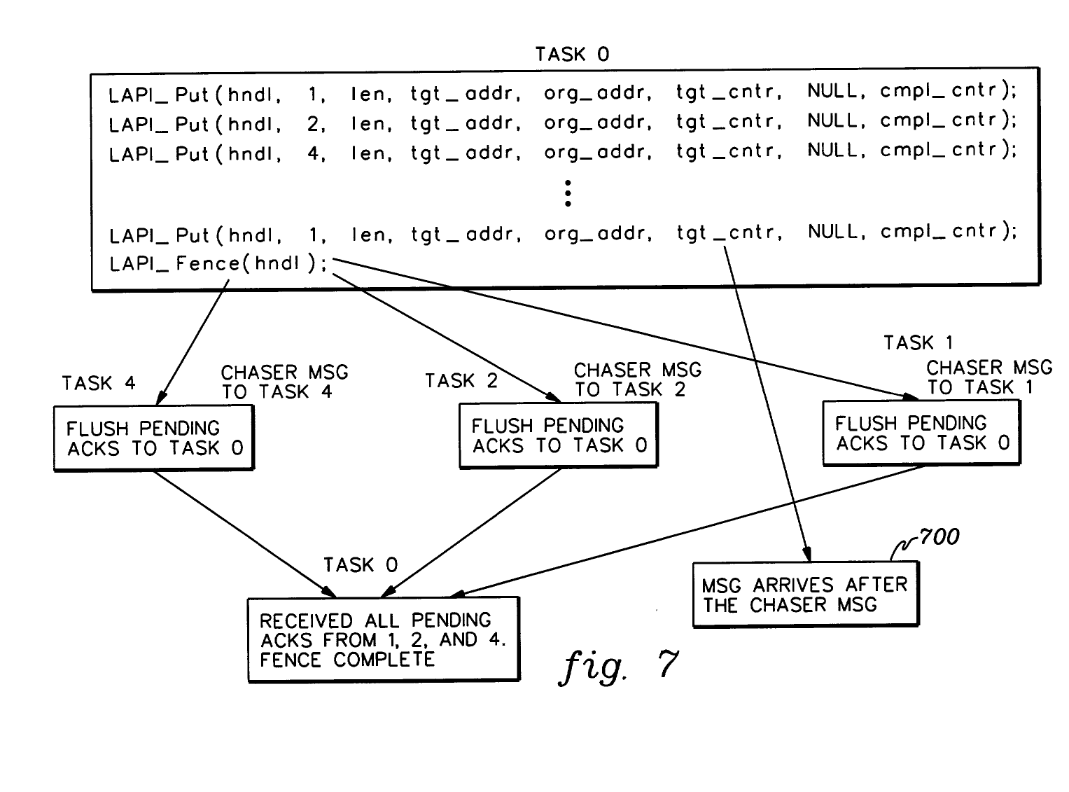

It should be noted that, in one embodiment, a race condition is possible, in which the chaser message overtakes a previous communication message. In that scenario, the receiving side, upon parsing the chaser message, will flush the pending acknowledgments; however, it will have failed to flush an acknowledgment back for the message just behind the chaser message (see 700 of FIG. 7). To address this race condition, the chaser message includes a sequence number indicating up to which packet the sender is expecting acknowledgments to be flushed back. The receiving side then waits for receipt of the packets up to the sequence number before flushing the acknowledgment back.

Described in detail above is a capability for managing the sending of acknowledgments, such as message completion acknowledgments, in a manner that improves latency, avoids deadlocks, and reduces the need for extra control messages. For example, for high performance and latency sensitive applications, performance is enhanced, while at the same time eliminating possible deadlock scenarios, when used in conjunction with certain operations, such as the Fence operation. Further, the number of packets sent over an unreliable network is minimized. Acknowledgments can now be delayed and pushed outside the critical path in situations that would normally not tolerate such delaying.

Although in the embodiments described above a thresholding technique is used to delay sending acknowledgments, this is only one example. Other delay techniques, such as a technique based on time or others, may be used without departing from the spirit of the present invention. Further, although in the above embodiments, all pending acknowledgments are flushed back in response to the chaser message, in other embodiments particular types of acknowledgments may be flushed, while others remain delayed.

Additionally, the premature sending of acknowledgments can be initiated based on reasons other than a Fence call. For instance, it can be based on other functions that cause a deadlock scenario or for any other reasons in which it is determined that the acknowledgments are to be prematurely flushed back to the sender. Although in the embodiments described above, the LAPI communications library is making the determination and initiating the sending of the chaser messages, other entities or components of the computing environment may be given one or more of these responsibilities.

The distributed computing environment described herein is only one example. It is possible to have more or less than eight frames, or more or less than sixteen nodes per frame. Further, the processing nodes do not have to be RISC/6000 computers running AIX. Some or all of the processing nodes can include different types of computers and/or different operating systems. Additionally, communications protocols, other than LAPI, may be used. All of these variations are considered a part of the claimed invention.

Further, aspects of the invention are useful with other types of computing environments and other types of communications environments. For example, one or more aspects of the present invention are useful with single system environments, and/or logically partitioned environments, in which one or more of the partitions of a node includes an operating system instance. Again, all of these variations are considered a part of the claimed invention.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of managing the sending of packet acknowledgments, said method comprising:
initially delaying sending at least one acknowledgment associated with one or more packets, until a first condition is satisfied;
detecting a second condition provoking the sending of the at least one acknowledgment, prior to satisfying the first condition; and
sending the at least one acknowledgment, in response to the detecting.

2. The method of claim 1, wherein said first condition comprises a threshold number of packets.

3. The method of claim 1, wherein said second condition comprises a potential deadlock.

4. The method of claim 1, wherein said second condition comprises a LAPI Fence call.

5. The method of claim 1, further comprising sending a message to one or more receivers of the one or more packets to initiate the sending of the at least one acknowledgment.

6. The method of claim 5, wherein the sending of the message is controlled by a communications library and is in response to the detecting of the second condition by the communications library.

7. The method of claim 5, wherein said message specifies a sequence number usable in identifying the one or more packets to be acknowledged in the at least one acknowledgment.

8. The method of claim 5, wherein said message specifies a sequence number usable in ensuring that the at least one acknowledgment acknowledges one or more packets sent prior to sending the message but received subsequent to the message.

9. The method of claim 1, wherein one or more acknowledgments of the at least one acknowledgment correspond to completion of one or more messages represented by one or more packets.

10. A method of managing the sending of packet acknowledgments, said method comprising:
determining that a delayed acknowledgment associated with one or more packets is to be prematurely sent; and
sending the delayed acknowledgment, in response to the determining.

11. The method of claim 10, wherein the determining comprises detecting a potential deadlock.

12. The method of claim 10, further comprising sending a message to a receiver of the one or more packets to initiate the sending of the delayed acknowledgment.

13. A system of managing the sending of packet acknowledgments, said system comprising:
means for initially delaying sending at least one acknowledgment associated with one or more packets, until a first condition is satisfied;
means for detecting a second condition provoking the sending of the at least one acknowledgment, prior to satisfying the first condition; and
means for sending the at least one acknowledgment, in response to the detecting.

14. The system of claim 13, wherein said first condition comprises a threshold number of packets.

15. The system of claim 13, wherein said second condition comprises a potential deadlock.

16. The system of claim 13, wherein said second condition comprises a LAPI Fence call.

17. The system of claim 13, further comprising means for sending a message to one or more receivers of the one or more packets to initiate the sending of the at least one acknowledgment.

18. The system of claim 17, wherein the means for sending the message comprises a communications library.

19. The system of claim 17, wherein said message specifies a sequence number usable in identifying the one or more packets to be acknowledged in the at least one acknowledgment.

20. The system of claim 17, wherein said message specifies a sequence number usable in ensuring that the at least one acknowledgment acknowledges one or more packets sent prior to sending the message but received subsequent to the message.

21. The system of claim 13, wherein one or more acknowledgments of the at least one acknowledgment correspond to completion of one or more messages represented by one or more packets.

22. A system of managing the sending of packet acknowledgments, said system comprising:
means for determining that a delayed acknowledgment associated with one or more packets is to be prematurely sent; and
means for sending the delayed acknowledgment, in response to the determining.

23. The system of claim 22, wherein the means for determining comprises means for detecting a potential deadlock.

24. The system of claim 22, further comprising means for sending a message to a receiver of the one or more packets to initiate the sending of the delayed acknowledgment.

25. A system of managing the sending of packet acknowledgments, said system comprising:
at least one receiver to initially delay sending at least one acknowledgment associated with one or more packets, until a first condition is satisfied;
a component to detect a second condition provoking the sending of the at least one acknowledgment, prior to satisfying the first condition; and
the at least one receiver to send the at least one acknowledgment, in response to the detecting.

26. The system of claim 25, wherein the component comprises a communications library.

27. A system of managing the sending of packet acknowledgments, said system comprising:
a component to determine that a delayed acknowledgment associated with one or more packets is to be prematurely sent; and
a receiver to send the delayed acknowledgment, in response to the determining.

28. The system of claim 27, wherein the component and the receiver are of the same node.

29. The system of claim 27, wherein the component and the receiver are of different nodes.

30. At least one program storage device readable by a machine tangibly embodying at least one program of instructions executable by the machine to perform a method of managing the sending of packet acknowledgments, said method comprising:
initially delaying sending at least one acknowledgment associated with one or more packets, until a first condition is satisfied;
detecting a second condition provoking the sending of the at least one acknowledgment, prior to satisfying the first condition; and
sending the at least one acknowledgment, in response to the detecting.

31. The at least one program storage device of claim 30, wherein said first condition comprises a threshold number of packets.

32. The at least one program storage device of claim 30, wherein said second condition comprises a potential deadlock.

33. The at least one program storage device of claim 30, wherein said second condition comprises a LAPI Fence call.

34. The at least one program storage device of claim 30, wherein said method further comprises sending a message to one or more receivers of the one or more packets to initiate the sending of the at least one acknowledgment.

35. The at least one program storage device of claim 34, wherein the sending of the message is controlled by a communications library and is in response to the detecting of the second condition by the communications library.

36. The at least one program storage device of claim 34, wherein said message specifies a sequence number usable in identifying the one or more packets to be acknowledged in the at least one acknowledgment.

37. The at least one program storage device of claim 34, wherein said message specifies a sequence number usable in ensuring that the at least one acknowledgment acknowledges one or more packets sent prior to sending the message but received subsequent to the message.

38. The at least one program storage device of claim 30, wherein one or more acknowledgments of the at least one acknowledgment correspond to completion of one or more messages represented by one or more packets.

39. At least one program storage device readable by a machine tangibly embodying at least one program of instructions executable by the machine to perform a method of managing the sending of packet acknowledgments, said method comprising:
determining that a delayed acknowledgment associated with one or more packets is to be prematurely sent; and
sending the delayed acknowledgment, in response to the determining.

40. The at least one program storage device of claim 39, wherein said method further comprises sending a message to a receiver of the one or more packets to initiate the sending of the delayed acknowledgment.
